(19) United States
(12) Patent Application Publication
(10) Pub. No.: US 2004/0265550 A1
(43) Pub. Date: Dec. 30, 2004

(54) Optically transparent nanostructured electrical conductors

(76) Inventors: Paul J. Glatkowski, Littleton, MA (US); David J. Arthur, Norwood, MA (US)

Correspondence Address: MORRISON & FOERSTER LLP, 1650 TYSONS BOULEVARD, SUITE 300, MCLEAN, VA, 22102, US

(21) Appl. No.: 10/729,369

(22) Filed: Dec. 8, 2003

Related U.S. Application Data
(60) Provisional application No. 60/431,202, filed on Dec. 6, 2002.

(51) Int. Cl. B32B 3/00

(52) U.S. Cl. 428/209

(57) ABSTRACT

The invention is directed to compositions and methods for forming highly transparent and electrically conductive coatings/films by exploiting self patterning nanostructures composed of electrically conductive materials. The resulting layer is suitable for conducting electricity in applications where a transparent electrode is required. Typical applications include, but are not limited to; LC displays, touch screens, EMI shielding windows, and architectural windows. In one embodiment, carbon nanotubes are applied to an insulating substrate to form an electrically conductive network of nanotubes with controlled porosity in the network. The open area, between the networks of nanotubes, increases the optical transparency in the visible spectrum while the continuous nanotube phase provides electrical conductivity across the entire surface or patterned area. Through the controlled application of this self assembled network of nanotubes of by means of printing or spraying, patterned areas can be formed to function as electrodes in devices. The use of printing technology to form these electrodes obviates the need for more expensive process such as vacuum deposition and photolithography typically employed today during the formation of ITO coatings.

### REFERENCE TO RELATED APPLICATIONS

This application claims priority to U.S. Provisional Patent Application No. 60/431,202 entitled “Highly Optically Transparent Nanostructured Electrical Conductors” filed Dec. 6, 2002.

### BACKGROUND

1. Field of the Invention

The invention is directed to transparent patterned electrically conductive coatings and films and methods for forming such coatings and films.

2. Description of the Background

Carbon nanotubes are the most recent addition to the growing members of the carbon family. Carbon nanotubes can be viewed as a graphite sheet rolled up into a nanoscale tube form to produce the so-called single-wall carbon nanotubes (SWNT) Harris, P. F. “Carbon Nanotubes and Related Structures: New Materials for the Twenty-first Century”, Cambridge University Press: Cambridge, 1999. There may be additional graphene tubes around the core of a SWNT to form multi-wall carbon nanotubes (MWNT). These elongated nanotubes may have a diameter in the range from few angstroms to tens of nanometers and a length of several micrometers up to millimeters. Both ends of the tubes may be capped by fullerene-like structures containing pentagons. Carbon nanotubes can exhibit semiconducting or metallic behavior (Dai, L.; Mau, A. W. M. Adv. Mater. 2001, 13, 899). They also possess a high surface area (400 m²/g for nanotube “paper”) (Niu, C.; Sichel, E. K.; Hoch, R.; Moy, D.; Tennent, H. “High power electrochemical capacitors based on carbon nanotube electrodes”, Appl. Phys. Lett. 1997, 70, 1480-1482), high electrical conductivity (5000 S/cm) (Dresselhaus, M. Phys. World 1996, 9, 18), high thermal conductivity (6000 W/mK) and stability (stable up to 2800° C. in vacuum) (Collins, P. G.; Avouris, P. “Nanotubes for electronics”, Sci. Am. 2000, Dec. 62-69) and good mechanical properties (tensile strength 45 billion pascals).

Most transparent electrodes are made from metal or metal oxiode coatings applied to an optically transparent substrate by, for example, vacuum deposition, chemical vapor deposition, chemical bath deposition, sputtering, evaporation, pulsed vapor deposition, sol-gel methods, electroplating, and spray pyrolysis. When desired, these coatings can be patterned with costly photolithographic techniques. This process is difficult and expensive to scale up to cover large areas with electrodes. In addition, the resulting coating, being based on a metal oxide, is rigid thereby preventing use in flexible applications such as in plastic displays, plastic solar voltaic, and wearable electrical circuitry.

Thus there is a need for new electrically conductive, optically transparent coatings and films that are transparent, conductive, flexible and processed using large area patterning and ablative techniques at low cost.

### SUMMARY OF THE INVENTION

The present invention overcomes problems and disadvantages associated with current strategies and designs and provides compositions and methods for forming highly transparent and patterned electrically conductive coatings, films and other surface coverings by exploiting the patterning of electrically conductive materials at either or both a macroscopic scale and/or a nanoscopic scale.

One embodiment of the invention is directed to transparent conductors comprising carbon nanotubes (CNT) applied to an insulating substrate to form a transparent and patterned electrically conductive network of carbon nanotubes with controlled porosity in the network. Such conductors can be formed with varying degrees of flexibility. The open area between the networks of carbon nanotubes increases the optical transparency in the visible spectrum while the continuous carbon nanotube phase provides electrical conductivity across the entire surface or just the patterned area. Through the controlled application of this self-assembled network of carbon nanotubes, patterned areas are formed to function as electrodes in devices. Processes for the application of carbon nanotubes includes, but is not limited to printing, sputtering, painting, spraying and combinations thereof. Printing technology used to form these electrodes obviates any need for more expensive process such as vacuum deposition and photolithography typically employed today during the formation of indium tin oxide (ITO) coatings.

Another embodiment of the invention is directed to methods for forming transparent conductors comprising carbon nanotubes applied to an insulating substrate to form an electrically conductive network of carbon nanotubes. Such methods can be used to produce conductors with varying degrees of flexibility.

Another embodiment of the invention is directed to films, coatings and other coverings, partial or complete, comprising carbon nanotubes applied to a substrate that form a transparent, patterned electrically conductive network.

Other embodiments and advantages of the invention are set forth, in part, in the following description and, in part, may be obvious from this description, or may be learned from the practice of the invention.

### DESCRIPTION OF THE FIGURES

FIG. 1 Percent optical transmission vs. thickness.

FIG. 2 SEM image of conductive patterned coating.

FIG. 3 Description of patterned structure (A) and patterned structure between two layers of clear substrate (B).

FIG. 4 Opto-electronic properties at different thicknesses.

FIG. 5 TEM image of SWNT coating.

FIG. 6 TEM image of SWNT coating.

FIG. 7 TEM image of SWNT stretch across a tear in a carbon nanotube film.

FIG. 8 Optical micrograph (200X) of SWNT film with spots of release material.

FIG. 9 Optical micrograph (200X) of SWNT film with holes formed during removal of underlying release film.

FIG. 10 Illustration of flexible transparent electrodes and circuits by carbon nanotube patterning.

### DESCRIPTION OF THE INVENTION

The invention relates to films and coatings, and articles partially or completely coated with such films and coatings, that are both electrically conductive and transparent. The invention further relates to methods of forming such films and coatings that are both transparent and conductive, and may be flexible.

Electrical conducting materials are mostly opaque and generally considered to be poorly transparent even when formed into a film. Transparency of the film is a function of the film's thickness and the size and number of holes created by the patterning. However, some conductors are known to be at least partly transparent such as gold, titanium, zinc, silver, cadmium, indium, selenium, and various compounds thereof (e.g. SnO₂, TiN, In₂O₃, ZnO, Cd₂SnO₃, ZnSnO₃, TiN, Cd₂SnO₄) (for a review of transparent conductors see Material Research Society Bulletin, pp55-57, by Roy G. Gordon, August 2000; which is entirely incorporated by reference).

It has been surprisingly discovered that transparency can be increased without a proportional loss of conductivity. In one embodiment, electrically conductive materials can be assembled into macroscopic patterns on surfaces that result in increased transparency as compared to unpatterned surfaces. In addition, by varying the design of the patterns, complex filters can be created that polarize radiation or completely block one or more wavelengths and not others.

Transparent conductive materials have a Figure of Merit. The Figure of Merit is the ratio of electrical conductivity (a) over the visible absorption coefficient (a), for a particular thickness, as determined by the formula:

Figure of Merit=σ/α=−{R₃In(T+R)}⁻¹

in which R₃ is the sheet resistance in Ohms/square, T is the total visible transmission, and R is the total visible reflectance. Thus, σ/α is a merit for rating transparent conductors and an effective transparent conductor should have high electrical conductivity combined with low absorption of visible light. Surprisingly, when only end use applications are considered (e.g. “R₃” or sheet resistance in Ohms/square and “T” or total visible transmission), patterns with increased transmission and sufficient conductivity can be selected. For any given transparent conductive material, by choosing combinations of material thickness and percent filled area for the pattern, one can achieve specific criteria for light transmission and sheet resistance. For example, as shown in Table 1, graphite patterns with filled areas of from 20% to 60% (0.2 to 0.6), at a thickness of 8 nm allows for the transmission of light at greater than 90% and sheet resistance less than 500 Ohms/square. Similarly, gold patterns with filled areas of from 5% to 10% (0.05 to 0.1), at a thickness of 25 nm allows for the transmission of light at greater than 90% and sheet resistance less than 100 Ohms/square (see Table 2). Thus, by knowing the electrical conductivity and visible absorption coefficient, the degree of transparency and sheet resistance can be computed for any transparent conductive material, and the desired combination of patterning and thickness selected.

Another embodiment of the invention is directed to electrically conductive materials comprising carbon nanotubes that, when assembled into nanoscopic patterns on surfaces, surprisingly provide an increased transparency with a conductivity. Carbon nanotubes are known and have a conventional meaning (R. Saito, G. Dresselhaus, M. S. Dresselhaus, “Physical Properties of Carbon Nanotubes,” Imperial College Press, London U.K. 1998, or A. Zettl “Non-Carbon Nanotubes” Advanced Materials, 8, p. 443, 1996). Carbon nanotubes comprises straight and/or bent multi-walled nanotubes (MWNT), straight and/or bent double-walled nanotubes (DWNT), and straight and/or bent single-walled nanotubes (SWNT), and combinations and mixtures thereof. CNT may also include various compositions of these nanotube forms and common by-products contained in nanotube preparations such as described in U.S. Pat. No. 6,333,016 and WO 01/92381, and various combinations and mixtures thereof. Carbon nanotubes may also be modified chemically to incorporate chemical agents or compounds, or physically to create effective and useful molecular orientations (see U.S. Pat. No. 6,265,466), or to adjust the physical structure of the nanotube.

In a preferred embodiment, the nanotubes comprise single walled carbon-based SWNT-containing material. SWNTs can be formed by a number of techniques, such as laser ablation of a carbon target, decomposing a hydrocarbon, and setting up an arc between two graphite electrodes. For example, U.S. Pat. No. 5,424,054 to Bethune et al. describes a process for producing single-walled carbon nanotubes by contacting carbon vapor with cobalt catalyst. The carbon vapor is produced by electric arc heating of solid carbon, which can be amorphous carbon, graphite, activated or decolorizing carbon or mixtures thereof. Other techniques of carbon heating are discussed, for instance laser heating, electron beam heating and RF induction heating. Smalley (Guo, T., Nikoleev, P., Thess, A., Colbert, D. T., and Smally, R. E., Chem. Phys. Lett. 243: 1-12 (1995)) describes a method of producing single-walled carbon nanotubes wherein graphite rods and a transition metal are simultaneously vaporized by a high-temperature laser. Smalley (Thess, A., Lee, R., Nikolaev, P., Dai, H., Petit, P., Robert, J., Xu, C., Lee, Y. H., Kim, S. G., Rinzler, A. G., Colbert, D. T., Scuseria, G. E., Tonarek, D., Fischer, J. E., and Smalley, R. E., Science, 273: 483-487 (1996)) also describes a process for production of single-walled carbon nanotubes in which a graphite rod containing a small amount of transition metal is laser vaporized in an oven at about 1,200° C. Single-wall nanotubes were reported to be produced in yields of more than 70%. U.S. Pat. No. 6,221,330 discloses methods of producing single-walled carbon nanotubes which employs gaseous carbon feedstocks and unsupported catalysts.

SWNTs are very flexible and aggregate to form bundles of tubes called ropes and eventually snakes (i.e. aggregates of ropes). The formation of SWNT ropes and snakes in the coating or film allows the conductivity to be very high, while loading to be very low, and results in a good transparency and low haze. The instant films provide excellent conductivity and transparency at relatively low loading of nanotubes. In various preferred embodiments, nanotubes are present in the films from about 0.001% to about 50%, or from about 0.1% to about 30%, or from about 2% to about 25%, or from about 5% to about 15%. Percents may be based on weight or volume. Preferably, the nanotubes are present in said film from about 0.01% to about 10%, which results in a good transparency and low haze. The layer may have a surface resistance in the range of about 10⁻² to about 10¹² Ohms/square, preferably about 10² to about 10¹² Ohms/square, more preferably about 10³ to about 10¹⁰ Ohms/square, and even more preferably about 10⁵ to about 10⁹ Ohms/square. Accordingly, the layer of nanotubes can provide adequate electrostatic discharge protection within this range. The instant films also have volume resistivity in the range of about 10⁻² Ohms-cm to about 10¹⁰ Ohms-cm. Surface and volume resistivities are determined as defined in ASTM D4496-87 and ASTM D257-99.

Total light transmittance refers to the percentage of energy in the electromagnetic spectrum that passes through the one or more layers. With visible light, this includes wavelengths of about 400 nm to about 700 nm. However, by selecting the particular composition of carbon nanotubes and optionally other electrically conductive materials (e.g. conducting polymers, metals particulates, inorganic particulates, organometallic materials and combinations and mixtures thereof), any range or plurality of ranges or specific values of the EM spectrum can be selectively blocked or selectively allowed to pass through the coating. For example, by altering the composition (e.g. nanotube amount or type, additional of one or more conductive metals or other components) and/or pattern (e.g. polarized, mesh screen), specific wavelengths of EM can be selectively blocked for infrared (near or far), ultraviolet, x-ray, electric power, radio waves, microwaves, or any combination or part thereof. Blockage or selective transmission can be for most any relative amount from 1% or less to 99% or more (in comparison to the amount without selective blockage or transmission, respectively). In various preferred embodiments, the film has a total EM transmittance (preferably of visible light) of about 70% or more, or 80% or more, or 90% or more, or even 95% or more. In another preferred embodiment, the layer advantageously has an optical transparency retention of about 80% to about 99.9% of that of any base material before nanotubes are added. In another preferred embodiment, the layer has a haze value of 30% or less, which includes 25% or less, 20% or less, 15% or less, 10% or less, 5% or less and 1% or less. In another preferred embodiment, film has a haze value of 0.5% or less, 0.1% or less, or even lower.

Films and coatings of the invention may range in thickness between about 0.5 nm or less to about 1,000 microns or more. In a preferred embodiment, the layer may further comprises a polymeric material. The polymeric material may be selected from a wide range of natural or synthetic polymeric resins. The particular polymer may be chosen in accordance with the strength, structure, or design needs of a desired application. In a preferred embodiment, the polymeric material comprises a material selected from the group consisting of thermoplastics, thermosetting polymers, elastomers and combinations thereof. In another preferred embodiment, the polymeric material comprises a material selected from the group consisting of polyethylene, polypropylene, polyvinyl chloride, styrenic, polyurethane, polyimide, polycarbonate, polyesters, fluoropolymers, polyethers, polyacrylates, polysulfides, polyamides, acrylonitriles, cellulose, gelatin, chitin, polypeptides, polysaccharides, polynucleotides and mixtures thereof. In another preferred embodiment, the polymeric material comprises a material selected from the group consisting of ceramic hybrid polymers, phosphine oxides and chalcogenides.

In another preferred embodiment, the layer may further have an additive selected from the group consisting of a dispersing agent, a binder, a cross-linking agent, a stabilizer agent, a coloring agent, a UV absorbent agent, and a charge adjusting agent. Preferably the layer does not include a binding agent. Particularly, the nanotubes may be combined with additives to enhance electrical conduction, such as conductive polymers, particulate metals, particulate ceramics, salts, ionic additives and combinations and mixtures thereof.

The layer may be easily formed and applied to a substrate as a fluid dispersion or suspension of nanotubes alone or in such solvents as, for example, acetone, water, ethers, alcohols (e.g. ethanol, isopropanol), gasses, gels, and combinations and mixtures thereof. The solvent may be selectively removed by normal processes such as air drying, heating or reduced pressure to form the desired film of nanotubes. The layer may be applied by other known processes including, but not limited to processes such as spray painting, dip coating, spin coating, knife coating, kiss coating, gravure coating, screen printing, ink jet printing, pad printing, other types of printing, roll coating or combinations thereof.

The instant films may be in a number of different forms including, but not limited to, a solid film, a partial film, a foam, a gel, a semi-solid, a powder, a fluid, or combinations thereof. In a preferred embodiment, the instant nanotube films can themselves be over-coated with a polymeric material. In this way, the invention contemplates, in a preferred embodiment, novel laminates or multi-layered structures comprising films of nanotubes overcoated with another coating of an inorganic or organic polymeric material. These laminates can be easily formed based on the foregoing procedures and are highly effective for distributing or transporting electrical charge. The layers, for example, may be conductive, such as tin-indium mixed oxide (ITO), antimony-tin mixed oxide (ATO), fluorine-doped tin oxide (FTO), aluminum-doped zinc oxide (FZO) layer, or provide UV absorbance, such as a zinc oxide (ZnO) layer, or a doped oxide layer, or a hard coat such as a silicon coat. In this way, each layer may provide a separate characteristic.

In a preferred embodiment, the nanotubes are oriented on a molecular level by exposing the films to a shearing, stretching, or elongating step or the like, for example, but not limited to, using conventional polymer processing methodology. Such shearing-type processing refers to the use of force to induce flow or shear into the film, forcing a spacing, alignment, reorientation, disentangling etc. of the nanotubes from each other greater than that achieved for nanotubes simply formulated either by themselves or in admixture with polymeric materials. Oriented nanotubes are discussed, for example in U.S. Pat. No. 6,265,466. Such disentanglement etc. can be achieved by extrusion techniques, application of pressure more or less parallel to a surface of the composite, or application and differential force to different surfaces thereof, e.g., by shearing treatment by pulling of an extruded plaque at a variable but controlled rate to control the amount of shear and elongation applied to the extruded plaque. It is believed that this orientation results in superior properties of the film, e.g., enhanced electromagnetic (EM) shielding.

Circuits of electrically conductive material can be achieved by any of a number of conventional methods known in the field. Circuits can be created to maximize conductivity, surface or volume resistivity, or another physical parameter, between conductive materials, between layers, or across a surface. Useful circuits include, but are not limited to, integrated circuit patterns, patterns to create a polarizing layer (or plurality of layers), and any desired electrical connection. Circuits may be created to maximize contact with other electrodes without sacrificing transparency.

The layers of the instant invention advantageously achieve acceptable electrical conductivity while not negatively effecting properties of polymeric materials in the layer. In fact, properties of base polymeric materials can be substantially maintained after addition of nanotubes effective for electrostatic discharge. For example, in a preferred embodiment, the layer has a tensile elongation retention of at least 50% of that of a nanotube-free base polymeric materials. More preferably, the layer has a tensile elongation retention of at least 70% of that of a nanotube-free base polymeric materials. Even more preferably, the layer has a tensile elongation retention of at least 90% of that of a nanotube-free base polymeric materials. In another preferred embodiment, the layer has a coefficient of thermal expansion (CTE) that is at least 50% of that of a nanotube-free base polymeric material. More preferably, the layer has a coefficient of thermal expansion (CTE) that is at least 70% of that of a nanotube-free base polymeric material. Even more preferably, the layer has a coefficient of thermal expansion (CTE) that is at least 90% of that of a nanotube-free base polymeric material. Also preferred is an embodiment wherein carbon nanotubes are molecularly oriented. Oriented refers to the axial direction of the nanotubes. The tubes can either be randomly oriented, orthogonally oriented (for example nanotube arrays), or preferably, the nanotubes are oriented in the plane of the film.

The instant invention utilizes advantageous properties of carbon nanotubes to incorporate electrical conductivity into durable polymeric layers without degrading optical transparency or mechanical properties or the patterns of conductive materials. In this way, the instant inventors utilize carbon nanotubes within the context of layers and films as a means of achieving sufficient electrical conductivity.

The following examples are offered to illustrate embodiments of the present invention, but should not be viewed as limiting the scope of the invention.

### EXAMPLES

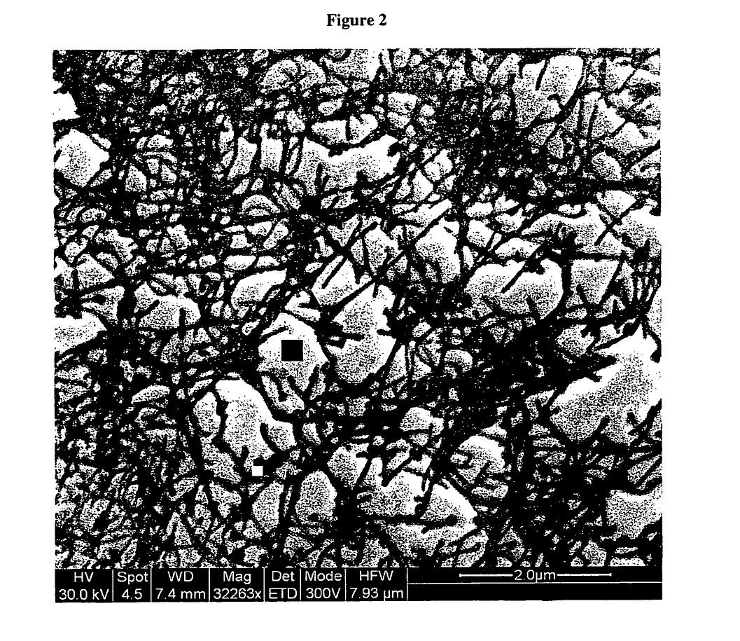

For the purposes of explanation of the concepts disclosed herein, examples are presented. The first example presents calculated results for a perfect layer of single crystal graphite at various thickness and with varying amount of open space created by a perfect pattern. The purpose is to demonstrate the effect that patterning and thickness have on optoelectronic properties. Secondly, an SEM micrograph of a spray coated carbon nanotube film is presented in FIG. 2.

The case for studying graphitic layers is based on the well understood optical and electrical behavior of the material and its close chemical structure and composition to that of carbon nanotubes. Graphite serves as an excellent model for understanding the behavior of other conductive materials and especially carbon nanotubes. Essentially carbon nanotubes are graphitic sheets with edges joined to form a tube. Carbon nanotubes have similar electrical conductivity as measured in the plane of graphite.

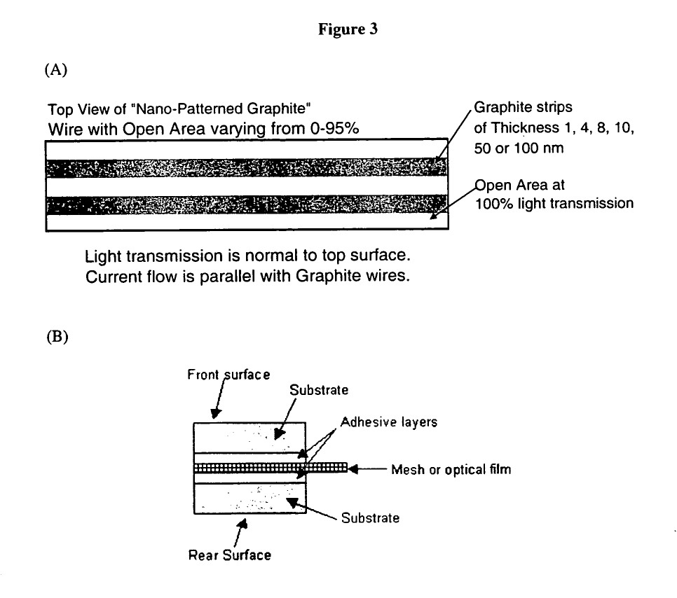

In the graphite based model optical and electrical properties can be calculated and compared to gain a first approximation of the value of controlling both the thickness and open pattern area of this semi-metallic compound. Essentially, the calculation determine the optical transparency of a patterned graphite films with open spaces uniformly formed therein, as illustrated in FIG. 3. The calculations are based a well known physical parameters and relationships.

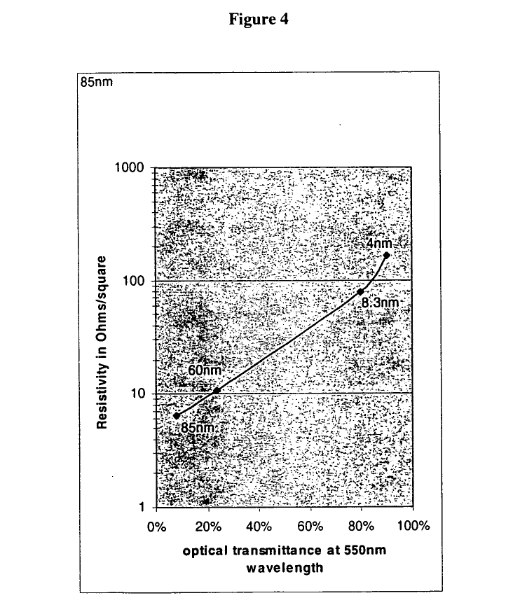

In FIG. 4 is a graph showing the optical transmittance of graphite as a function of electrical resistivity at four thicknesses. This graph represents an ideal continuous coating of single-crystal graphite and represents the expected optical transparency of the wire portion of the conductive pattern. In Table 1 is the result of taking the continuous coating and patterning of graphite by removing the state area (100%-fill area). Table 1 shows sum total transmission of light (from both the potion transmitted through the graphite and that transmitted through the open space). The shaded area is useful for touch screen applications. The data in bold type is good for flat panel computer displays and electroluminescent displays/lamps. The data suggest that thin wires (or small diameter ropes of nanotubes, which are thin) and modest open areas should work well for most of these applications. Also that thicker wire/conductor can be utilized if the open area is also increased.

TABLE 1

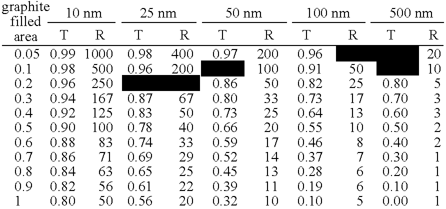

[Shaded areas represent T of at least 90% and R of no more than 100 Ohms/square]

Summary of model predictions for visible light transmittance (T) and sheet resistance (R, Ω/square).

TABLE 2

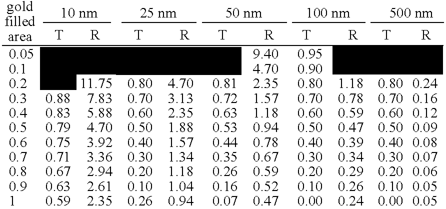

[Shaded areas represent T of at least 90% and R of no more than 100 Ohms/square]

TABLE 3

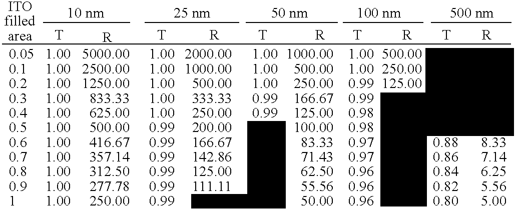

[Shaded areas represent T of at least 90% and R of no more than 100 Ohms/square]

Tables 2 and 3 show that optical transparency can be significantly increased for the transparent mesh or screen patterns, while maintaining high levels of conductivity (or low sheet resistance). Note that when filled area=1, that is the case for a continuous film of transparent conductor (no pattern).

TABLE 4

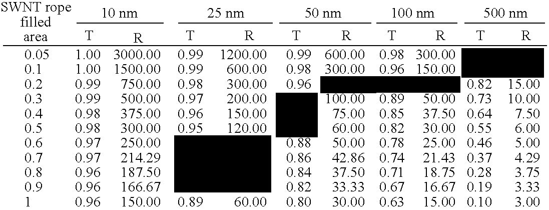

[Shaded areas represent T of at least 90% and R of no more than 100 Ohms/square]

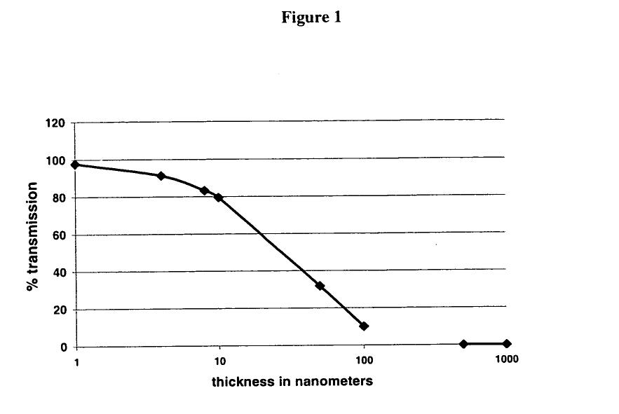

In creating patterned films, a layer may have a screen-like appearance with open areas enclosed by darker conductive areas. The open areas pass EM radiation without loss if the open space or gap is larger than ½ the wavelength of the light incident on the gap (Handbook of Electronic Materials, P. S. Neelakanta, CRC Press, p. 456). The continuous conductive phase making up the network also has a fraction of the incident light which transmits through dependant on a designed and controllable thickness. Graphite has a well understood optical transparency as a function of thickness (see FIG. 1). The combination of the light which passes through the conductive layer and the open spaces between the conductive areas, combine to transmit through the thickness a defined amount of light while also allowing electrical current to pass in the plan of the film.

A scanning electron micrograph (SEM) image of conductive patterned coating formed by spraying a solution of carbon nanotubes on to neat PET film is shown in FIG. 2. This coating exhibits electrical resistivity of 8×10⁵ Ohms per square and optical transparency of 99% Transmission (% T) at 550 nm. These same procedures can be used to produce coatings with 94% T at 5×10² Ohms per square resistivity. The black square near the center of the photograph represents the minimum area or gap required to pass one hundred percent of incident visible light assuming a wavelength of <600 nm. The white areas show open space between the conductive nanotube network. As can be seen a large percentage of the open area is larger than the black square and therefore will pass visible light without loss. White areas with gap smaller than ½ the square size will exhibit an exponentially increasing loss in % T. Even in the dark region some light transmits due to the thinness of the coatings. The combined transmission of light is 94% T.

G. Henig reported in Journal of Chem. Physics, vol. 43, p. 1201 (1965) that for highly oriented pyrolytic graphite, HOPG, of thickness=600 Angstroms=60 nm has an OD≅0.63 at a wavelength=5500 Angstroms. J. H. Zhang and P. C. Eklund have reported in J. Materials Research, vol. 2, p. 858 (1987) that HOPG of calculated thickness 850 Angstroms (85 nm) has an OD≅1.1 at a wavelength of 5500 Angstroms. A wavelength of 5,500 Angstroms corresponds to a photon of energy (2.255 electron volts). S. Mizushima et al. reported (J. Phys. Soc. Japan, vol. 30, p. 299, 1971) that natural graphite at room temperature has a resistivity of 50×10⁻⁶ Ohm-cm for 1,000 Angstrom thick films and a resistivity≅65×10⁻⁶ Ohm-cm for 600 Angstrom thick films. The calculated four points are plotted below with different optical transmission and ohms per square. One assumption is that HOPG and the natural graphite flakes are comparable. An average absorption coefficient was calculated from the experimental data and then used it to estimate the thickness and ohms per square of graphite films with 80% and 90% optical transmission.

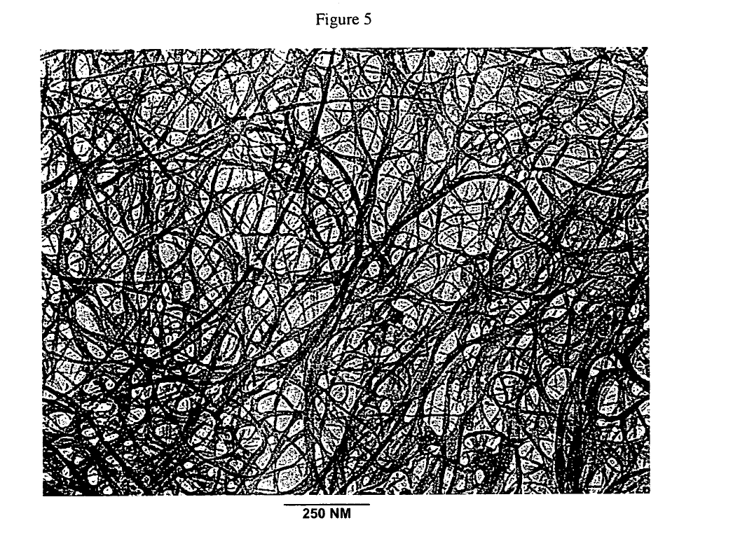

FIG. 5 depicts a transmission electron micrograph (TEM) image of SWNT coating showing network of ropes formed from individual nanotubes and the interconnection between the ropes. The growth of the interconnections and spacing of then interconnections allows for formation of an open network with both transparent conductive regions and transparent nonconductive regions which are essentially nanotube free. This coating was formed from a water solution containing SWNT which have under gone a process to purify and suspend them in water.

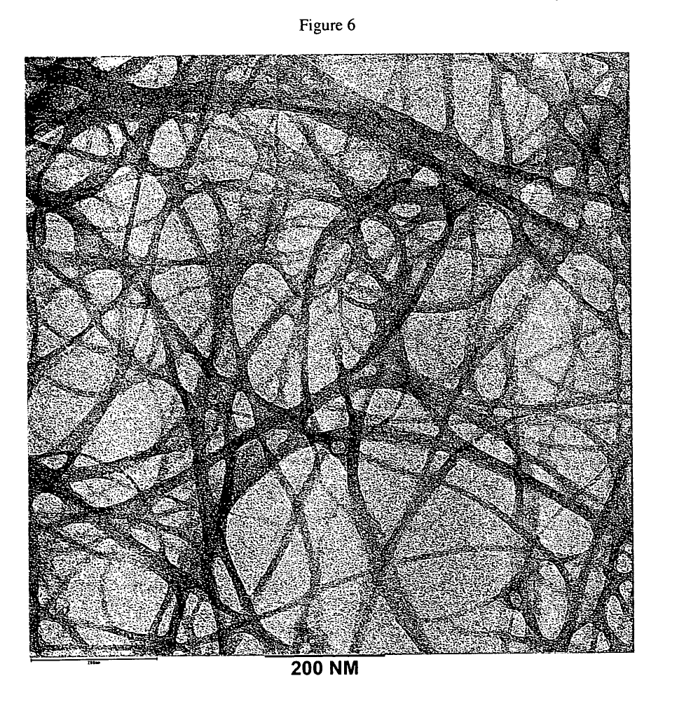

FIG. 6 depicts a TEM image of SWNT film formed by spray coating a solution. This film exhibits high optical transparency 99% T at 550 nm and 10⁵ Ohms/square resistivity. There is a high degree of interconnection between the ropes of nanotubes.

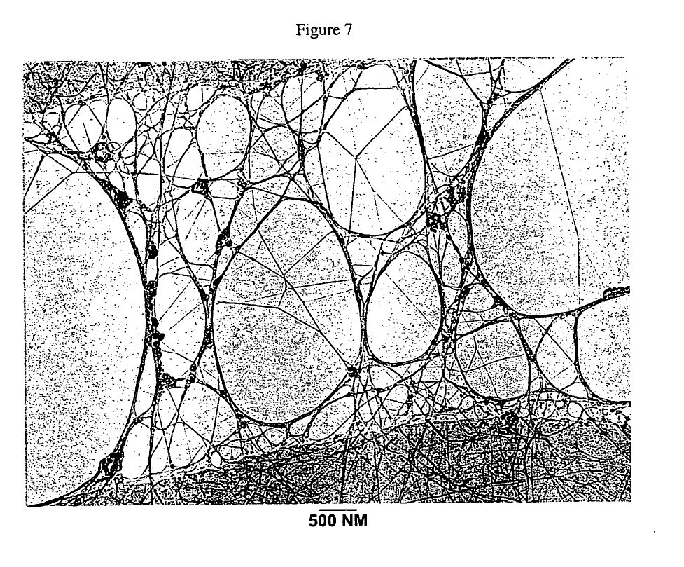

FIG. 7 depicts a TEM image of SWNT stretch across a tear in a film coated with nanotube ropes. The strong interconnection between ropes can be seen. No ends of ropes can be seen because, as ropes broke during the tearing operation, they reformed into other ropes to heal the network into a continuous pathway of nanotubes. Ends of ropes are not observed anywhere in these coatings.

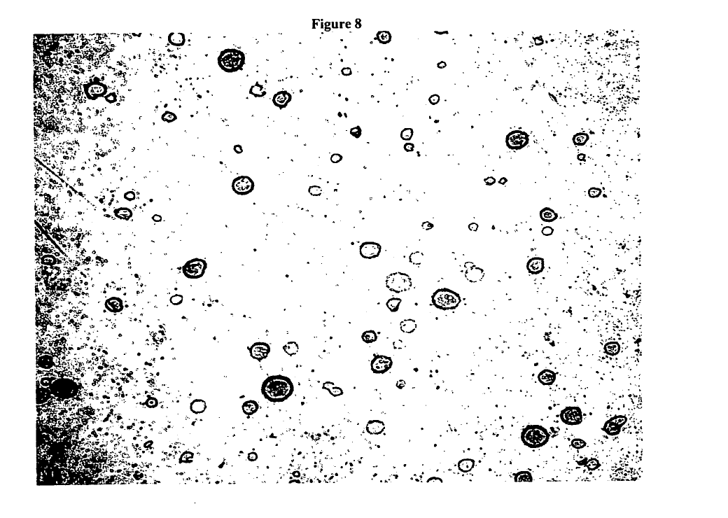

FIG. 8 depicts an optical micrograph (200X) of SWNT film with spots of release material as applied by a standard office laser printer. Spots are 50 to 100 micron in diameter. Photo is contrast enhance to shown the spots with the SWNT network as a grey film in the foreground. Individual ropes forming the network can not be imaged using optical microscopy.

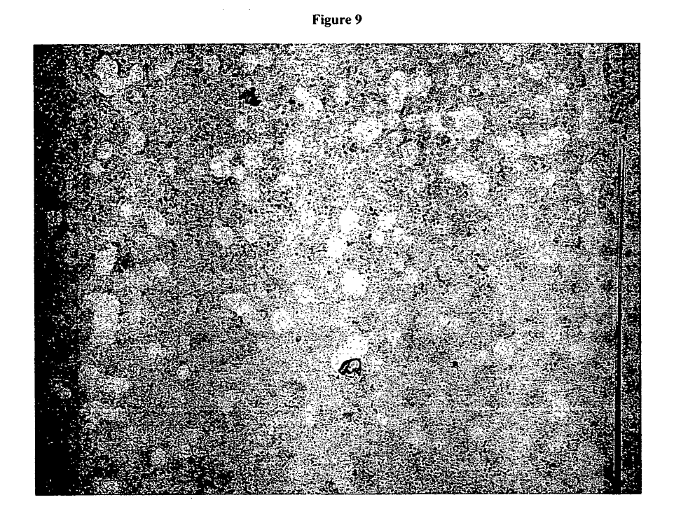

FIG. 9 depicts an optical micrograph (200X) of SWNT film with holes formed during removal of underlying release film. The smaller spot (measuring 0.5 to 1 micron) are amorphous carbon contaminates. Photo is contrast enhance to shown the SWNT network as a grey films. Individual ropes forming the network can not be imaged using optical microscopy.

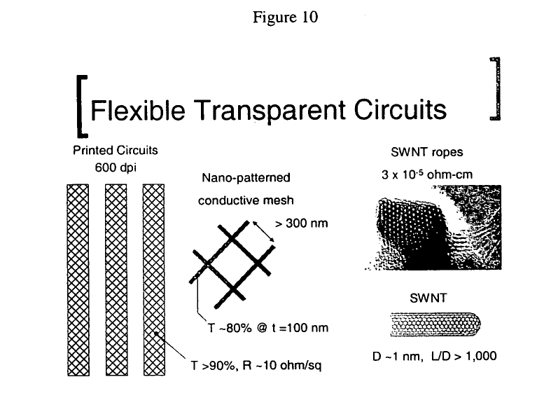

FIG. 10 illustrates that films such as circuits of the present invention can be made sufficiently transparent, sufficiently conductive and also flexible. Patterning of the film can be manufactured as desired, as opposed to as necessary, to allow for the transmission of EM radiation (e.g. visible light) through the film because the pattern itself does not necessarily impede EM transmission. Thus, highly desired patters can be created for specific purposes, while still retaining high transmissibility, low haze and high conductivity. Because carbon nanotubes are not brittle like ITO, the result is a very flexible film such that conductivity can be maintained across a film crease or most any bend of the substrate. Further, flexibility is high and resilient to multiple and repeated bendings (in the structure or through repeated use), even over long periods of time.

Transparent conductive electrodes can be fabricated by laminating a screen (or mesh) comprised of opaque conductive material (e.g. stainless steel, copper, gold, silver, brass) between two optically clear substrates (e.g. glass, Plexiglas, polycarbonate or other clear polymer plastics). One important application for such laminated structures is EMI/RFI shielding windows. High optical transparency is achieved by choosing a mesh opening that is much larger than the wavelength of visible light (λ between 400˜700 nm), yet much smaller than the wavelength of radiation that must be shielded (λ that are 1 mm and higher). Transparent conductive electrodes can be made by continuously coating plastic films such as PET or glass or plastic plates with transparent conductive coatings such as ITO, tin oxide, etc. A transparent conductive film with enhanced optical transparency can be formed by patterning a screen out of transparent conductive materials. This results in further improved optical transparency with modest trade-off in electrical conductivity.

Furthermore, some materials (like CNTs) lend themselves to more easily fabricate these desirable patterns due to self-assembly characteristics. Layers can be accomplished using any conductive material that can be patterned at the correct dimensions for a given spectral range. It is possible to form these patterned conductors using vapor deposited metal films which have been etched after lithographic techniques. The combination of processing steps required makes the whole process very expensive to complete with existing ITO operations. The value of this disclosure is in the use of conductive materials which spontaneously form a network or pattern as a result underlying physical properties inherent to the material. Single-walled and small diameter (<10 nm) double-walled carbon nanotubes may form ropes of individual nanotubes in their natural state. Roping can be exploited to form networks or screens on a surface which have open structures and a more detailed pattern than practically possible at this scale. Patterning can be encouraged through the use of surface preparation techniques such as scratching or rubbing.

Although transparent conductive coatings can be made form many materials, like metals, ITO and conducting polymers, the use of single walled nanotube offers a unique opportunity to form these layers. SWNT and in some cased double walled nanotubes can be formed as a rope of individual tubes that extend well beyond the length of the longest nanotube. Ropes interact with each other by sharing nanotubes, joining and separating in very gradual transitions. In fact single walled nanotube are not found normally in individual form but usually in ropes of various diameters and lengths depending on the conditions under which they formed. In this invention we exploit and control this assembly of SWNT to form conductive networks with enhanced optical transparency. Through modification of processing conditions, the formation of these coatings can be influenced. The resulting coatings exhibit a wide range of optical and electrical properties, most of which are not desirable in most applications. For example, inks prepared using chemically modified SWNT in solvent can be spray coated under a wide variety of conditions which yield coating with excellent to poor electronic and optical properties. By controlling drying rate, deposition rate, solution concentration, solvents, surfactants, and other additive, the formation of this nanotube network can be modified.

One form of modification is that under rapid drying conditions a spray coated ink will form small diameter ropes that have not fully integrated/merged into the network. The resulting film may contain the same amount of nanotubes per unit area, but exhibits high electrical resistivity. Conversely, if the spray coating is allowed to dry slowly on the substrate, then the ropes form into large diameters and aggregate to form a film with both poor electrical and optical properties. Furthermore, chemical modifications to the nanotubes prior to and during formation of the ink strongly affect the form to which the nanotubes take while in the ink. This ink will modify assembly of the nanotubes and nanotube network.

The attraction between individual nanotubes is very strong and always present. Any disruption/defect caused in a rope or network of ropes, results in what could be called self healing. This is basically the same effect as self assembly, but at a more local scale and takes place in ropes which may have already formed and may no longer be in the presence of solvent. This healing can be observed under an electron microscope. For example in FIG. 7, is a shown the end result of a SWNT film torn while being observed in a TEM. This micrograph shows that even though the film was torn in two, there are no ends of rope shown since all the ends were observed to reform into other ropes. In some cases ropes still span the gap formed. Even where the ropes are highly stretched, they gently merge and diverge smoothly to continue the network. This behavior can be exploited and manipulated to form networks with opening to pass EM radiation.

Films can be formed that include fugitive particles (particulate material) added or formed on top of substrates, for example, where small spots of a release film are applied. The particulate material includes, but is not limited to, beads and other forms of silica, acrylic, glass, plastic, carbon black, ceramics, metal and metal oxides, organic and inorganic materials, and combinations and mixtures thereof. These particles or release films become ensnared or covered by the network of ropes during film formation (see FIG. 8). The optical micrograph is not capable of showing the nanotube ropes since they are largely transparent and too small to be resolved by visible light; however the dark spots shown are spots of release-film, targeted for removal. These spots act as defects which can be removed from the film by immersion in liquid and exposure to ultrasonic energy. The resulting film has holes through the surface of the nanotube network. The nanotubes and ropes near the defect reform and create a smooth transition form the network to the hole caused by removal of the spots (see FIG. 8). The resulting film has higher optical transparency than that of the film containing the particles due to the creation of open holes in the film. The same is true even if the particles are not light absorbing. Alternatively, the hole could be formed by including particles of uniform size, like commercially available silica or amorphous carbon, in to the ink solution and form the films with these particles embedded. The particles can be removed by, for example, ultrasonic energy to enhance optical transparency and yield a film with similar characteristics as those depicted in the previous example.

Other embodiments and uses of the invention will be apparent to those skilled in the art from consideration of the specification and practice of the invention disclosed herein. All references cited herein, including all U.S. and foreign patents and patent applications, are specifically and entirely hereby incorporated herein by reference. It is intended that the specification and examples be considered exemplary only, with the true scope and spirit of the invention indicated by the following claims.

1. A electrically conductive patterned film comprising carbon nanotubes wherein said film has a transparency and an electrical resistivity.

2. The film of claim 1, wherein transparency is greater than 65%.

3. The film of claim 1, wherein transparency is greater than 85%.

4. The film of claim 1, wherein transparency is greater than 95%.

5. The film of claim 1, wherein the electrical resistivity is less than 10³ Ohms/square.

6. The film of claim 1, wherein the electrical resistivity is less than 10² Ohms/square.

7. The film of claim 1, wherein the electrical resistivity is less than 10¹ Ohms/square.

8. The film of claim 1, wherein the pattern is an integrated circuit.

9. The film of claim 1, wherein the pattern creates a polarizing effect for EM radiation that passes through said layer.

10. The film of claim 1, wherein the carbon nanotubes are selected from the group consisting of single-wall nanotubes, double-wall nanotubes, multi-wall nanotubes, chemically or physically modified nanotubes, and combinations and mixtures thereof.

11. The film of claim 1, further comprising conducting polymers, metals particulates, inorganic particulates, organometallic materials and combinations and mixtures thereof.

12. The film of claim 1, which is designed to transmit a range of the EM spectrum while shielding longer wavelengths.

13. The film of claim 1, wherein open spacing within said pattern permit radiation of >½ wavelength of incident radiation.

14. The film of claim 13, wherein incident radiation is from about 175 nm to 400 nm.

15. The film of claim 13, wherein incident radiation is from about 400 nm to 750 nm.

16. A transparent, electrically conductive film comprising:
a pattern of carbon nanotubes within said film, wherein said pattern provides an electrical resistivity of less than 10³ ohms/square and a visible transmission of at least 75%.

17. The film of claim 16, wherein the pattern of carbon nanotubes is contacted to two substrates, one on each surface of the pattern.

18. A method of forming a transparent film of patterned electrically conductive carbon nanotubes comprising:
patterning a fluid containing carbon nanotubes on a transparent surface to allow for electrical conductivity across at least a portion of said surface and a visible transparency.

19. The method of claim 18, wherein the fluid is sprayed, inkjet printed, flow coated, or screen printed from liquid solutions containing the conductive materials.

20. The method of claim 18, wherein the electrical resistivity is less than 10³ Ohms/square.

21. The method of claim 18, wherein the visible transmission is greater than 65%.

23. The method of claim 18, further comprising inclusion of a particulate material in said fluid.

24. The method of claim 23, wherein the particulate material is selected from the group consisting of silica, acrylic, glass, plastic, carbon black, beads, ceramics, metal and metal oxides, organic and inorganic materials, and combinations and mixtures thereof.

25. The method of claim 23, further compromising removing said particulate material and thereby enhancing optical transparency.

26. A electrically conductive patterned layer with enhanced transparency comprising:
a pattern of conductive material with a combination of a thickness and a pattern, said combination determined by computing an electrical conductivity and a visible absorption coefficient against a plurality of degrees of patterning and a plurality of material thicknesses.

27. The layer of claim 26, wherein the conductive material is selected from the group consisting of graphite, gold, ITO, a metal, carbon nanotubes, and combinations and mixtures thereof.

28. The layer of claim 26, wherein the conductive material is graphite and the combination is a thickness of about 8 nm and a pattern with a fill area of about 50%.

29. The layer of claim 26, wherein the conductive material is gold and the combination is a thickness of about 50 nm and a pattern with a fill area of about 5%.

30. The layer of claim 26, wherein the conductive material is ITO and the combination is a thickness of about 100 nm and a pattern with a fill area of about 70%.

31. The layer of claim 26, wherein the conductive material is carbon nanotubes and the combination is a thickness of about 25 nm and a pattern with a fill area of about 70%.

32. The layer of claim 26, wherein the transparency is at least 65% and the electrical resistivity is less than 10² Ohms/square.

33. A method of forming a patterned layer with enhanced transparency comprising:
patterning a conductive material on a substrate at a combination of a thickness and a pattern, said combination determined by:
computing an electrical conductivity and a visible absorption coefficient against a plurality of degrees of patterning and a plurality of material thicknesses.

34. The method of claim 33, wherein the conductive material is selected from the group consisting of graphite, gold, ITO, carbon nanotubes, and combinations and mixtures thereof.
